(19) United States
(12) Patent Application Publication
(10) Pub. No.: US 2012/0205314 A1
(43) Pub. Date: Aug. 16, 2012

(54) GRADIENT START UP SYSTEM

(76) Inventor: Dale A. Davison, Greenwood, NE (US)

(21) Appl. No.: 13/207,948

(22) Filed: Aug. 11, 2011

Related U.S. Application Data
(60) Provisional application No. 61/373,479, filed on Aug. 13, 2010.

(51) Int. Cl. B01D 15/08; B01D 15/10; B01D 15/42

(52) U.S. Cl. 210/656; 210/198.2; 210/541

(57) ABSTRACT

To provide or maintain pump prime in a liquid chromatographic system when changing solvents or solvent reservoirs or starting up a chromatographic run, first and second solvents are supplied to a mixer through corresponding first and second lines and from the mixer to a chromatographic column. Air in one of the lines is removed by a pump and the line is filled with solvent.

### RELATED CASES

This application is a continuation-in-part of U.S. provisional patent application 61/373,479 filed Aug. 13, 2010, for Gradient Start Up System. The applicant claims the benefit of provisional patent application 61/373,479.

### BACKGROUND OF THE INVENTION

This invention relates to gradient chromatography systems and more particularly to apparatus and methods for improving a gradient run by providing pump priming after initial start up or interruption of a run such as for changing solvent reservoirs during preparatory chromatography.

Techniques are known to provide or maintain pump prime in liquid chromatography when changing solvents or solvent reservoirs or starting a chromatographic run. These techniques are used to avoid some unprogrammed changes in solvent composition. One circumstance under which such an unprogrammed change in solvent composition may occur is when there is air in one of a plurality of solvent lines at start up. If the controller is programmed to cause the pumping system to pump 100 percent weak (e.g. low polarity) solvent from one line at start up and decrease the weak solvent from the one line as stronger solvent from a second line is increased and there is air in the second line, the unprogrammed change can occur. It occurs when the air is pumped out of the secondary line. At this time, there is a sudden unprogrammed increase in the strength of the solvent mixture applied to the column.

This sudden unprogrammed increase occurs even though the program calls for a continuous gradual increase in the strength of the solvent mixture applied to the column. Because the pumping system has been pumping air, the controller calls for a rate of pumping of the stronger solvent just as though it had been pumping strong solvent during the time it was pumping air. This sudden increase in solvent strength may remove several peaks at once without separating them.

One prior art technique for solving this problem is for the user to prime the fluid line before starting a separation The line is primed by manually applying solvent. This may avoid unprogrammed sudden changes in the solvent composition applied to the column but has the disadvantage of being time consuming.

Another circumstance under which an unprogrammed change in solvent composition may occur is when reservoirs are changed such as when solvent runs out or a different solvent is desired. The prior art technique for providing or maintaining the prime when changing reservoirs, is to temporarily block a solvent line. The line is blocked to maintain fluid in it until the new reservoir is connected. This technique has the disadvantages of being cumbersome and difficult in larger scale chromatography such as may be used in some preparatory chromatography since there are higher volumes of air to be blocked or replaced.

### SUMMARY OF THE INVENTION

Accordingly, it is an object of the invention to provide a novel method and apparatus for removing air from a fluid line in gradient preparatory chromatography.

It is a further object of the invention to provide a method for automatically insuring a supply of a solvent to a pump at the start of a chromatographic session.

It is a still further object of the invention to provide methods and apparatuses to avoid a sudden high unprogrammed increase in the strength of the solvent mixture applied to a chromatographic column during a chromatographic run.

It is a still further object of the invention to provide a novel method and apparatus for maintaining solvent in solvent lines having an internal diameter so large that the lines are not filled nor remain filled by capillary surface tension.

In accordance with the above and further objects of the invention, at least one of the lines from a solvent reservoir or other source of solvent has an auxiliary pump or other structure or equipment or technique for moving the solvent such as by gravity feed (hereinafter referred to as auxiliary solvent feeder) connected to it. The auxiliary solvent feeder is turned on or activated when the gradient solvent for that line is initially started or there is a change in solvent reservoirs or any other occasion in which air may enter the solvent line. The auxiliary solvent feeder removes any air in the line and fills the line with solvent. The auxiliary solvent feeder is preferably compatible with pumping air or liquid. Preferably, excess solvent is recirculated back to the solvent reservoir. This may be accomplished with a valve system capable of blocking the backflow of air or solvent or by using a recirculating line that is lower than the solvent line.

In the preferred embodiment, the pump is a reciprocating pump with a valve system built into it to open for the insertion of solvent and close to fill the cylinder with new solvent. Thus, the pump is substantially airtight during a fill cycle. In the preferred embodiment, a model KNF #NF5RTDCB-4, 10-28 volt, 4 wire brushless DC Micro Diaphragm liquid pump obtained from KNF Neuberger, Inc., two Black Forest Road, Trenton, N.J. 08691-1810 was used. Another suitable pump is a series D, Teledyne Isco pump available from Teledyne Isco, Inc., 4700 Superior St., Lincoln, Nebr. 68504.

The amount of time needed to pump the air from a line can be determined from the inner diameter and length of the line (i.e. volume) and the pumping rate of the auxiliary solvent feeder. The pumping may be discontinued after this time period. In the alternative, the pumping may be discontinued upon the detection of liquid at the escape point or high point of the line or the failure to detect air at this point. It has been proposed as an alternative, to incorporate foot valves (e.g. check valves at the inlet to the lines within the solvent reservoir) to hold the solvent in the line while the reservoir is disconnected. While this is a possible alternative to the preferred embodiment described above under some circumstances, it has the disadvantage when compared with the preferred embodiment under other circumstances of needing more pressure to form an adequate seal than the pressure provided by the solvent trapped in the line when the solvent reservoirs are changed and of still requiring priming at start up of the gradient system.

From the above description, it can be understood that the gradient elution start up systems of this invention has several advantages, such as: (1) they are automatic in their operation and do not waste operator time with priming; (2) they operate effectively even with large scale gradient chromatography such as may be used in preparatory chromatography including flash chromatography; and (3) they are relatively inexpensive in their operation.

### BRIEF DESCRIPTION OF THE DRAWINGS

The above noted and other features of the invention will be better understood from the following detailed description when considered in connection with the accompanying drawings, in which:

FIG. 1 is a block diagram of a gradient chromatographic system utilizing the priming method and apparatus of an embodiment of the invention;

FIG. 2 is a block diagram of one embodiment of the invention;

FIG. 3 is a block diagram of another embodiment of the invention;

FIG. 4 is a block diagram of still another embodiment of the invention;

FIG. 5 is a block diagram of still another embodiment of the invention;

FIG. 6 is a block diagram of still another embodiment of the invention; and

FIG. 7 is a schematic diagram of one embodiment of the invention.

### DETAILED DESCRIPTION

In FIG. 1, there is shown a block diagram of a chromatographic system 10 having a solvent supply system 12, at least one priming system or systems 14, a chromatographic elution, detection and/or collection system 15 and a controller 50. The priming system 14 communicates with the solvent supply system 12 which in the embodiment of FIG. 1 is a gradient former. The solvent supply system 12 communicates with the chromatographic elution, detection and/or collection system 15 through a conduit 25 to provide a gradient for elution of an eluent and the detection and collection of eluate. These systems are controlled by the controller 50 in a conventional manner as explained below.

More specifically, the chromatographic system 10 represents a configuration having three pumps (not shown in FIG. 1), three fluid reservoirs (not shown in FIG. 1), two priming systems 14 (not shown in FIG. 1) and the chromatographic elution, detection and/or collection system 15. The controller 50 communicates with the two priming systems through conductors 51B and 51C, to the three pumps through conductors 50A-50C respectively, and to the chromatographic elution, detection and/or collection system 15 through conductor 53 to control the operation of the system. Although a chromatographic system having three pumps, two priming systems and three solvent reservoirs respectively is represented by the block diagram 10, this configuration and other configurations having fewer or more pumps will be described in greater detail herein. The configuration of FIG. 1 is provided as an example since the number of solvents is variable and the exact manner in which the eluent is collected or detected will vary from system to system. In the preferred embodiment, the system is a flash chromatographic system.

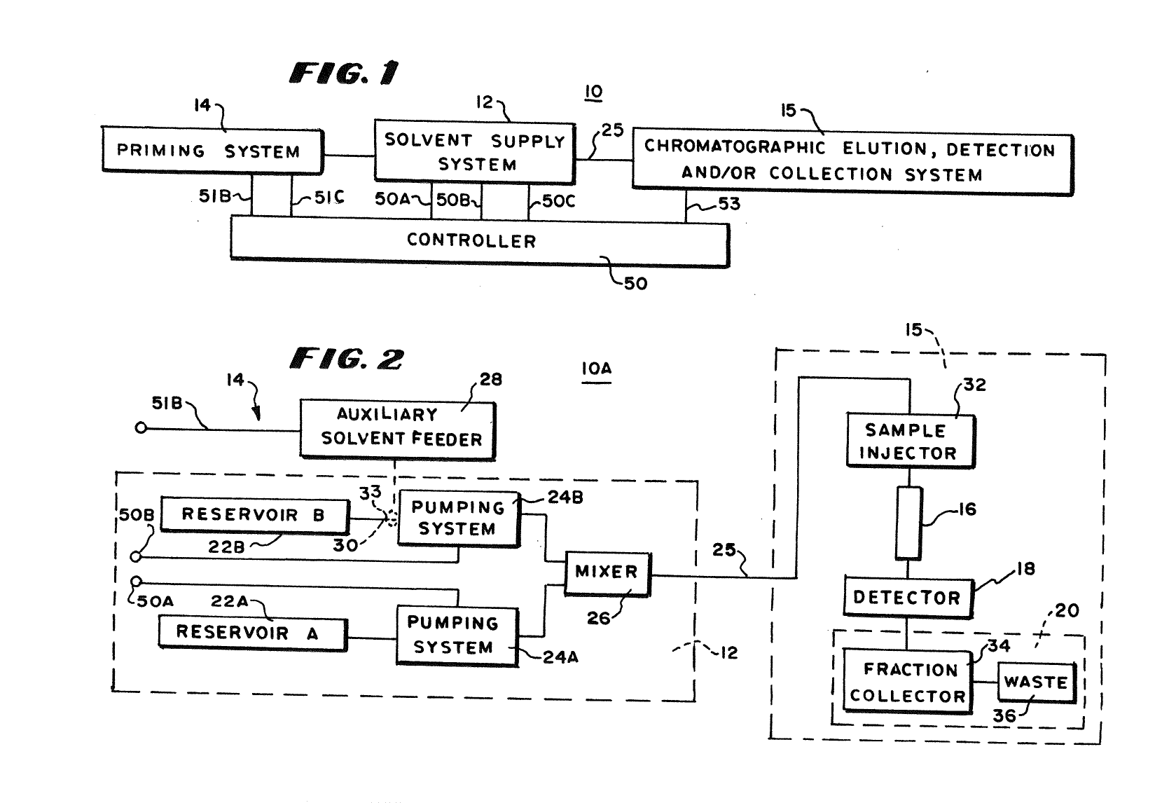

In FIG. 2, there is shown a fragmentary block diagram of a chromatographic system 10A having a solvent supply system 12, a priming system 14 and a chromatographic elution, detection and/or collection system 15. The chromatographic elution, detection and/or collection system 15 includes a column 16, a detector 18, an injector 32, the controller 50 (FIG. 1), and a fraction collection system 20. The solvent supply system 12 communicates with the start up or priming systems 14, the sample injector 32 and the column 16. The communication between the solvent supply system 12 and the column 16 is through the sample injector 32 in the preferred embodiment although a separate independent connection may be used in other embodiments. The sample injector 32, the column 16, the detector 18 and the fraction collection system 20 are connected in series in the order named.

The priming system 14 includes an auxiliary solvent feeder 28. In this embodiment, the solvent supply system 12 includes a gradient former having two solvents each in a respective one of two reservoirs: reservoir A indicated at 22A and reservoir B indicated at 22B. Each of these reservoirs communicates with a respective one of the two pumping system 24A and 24B. The pumping systems are under the control of conductors 50A and 50B from the controller 50 (FIG. 1) to supply varying amounts of each of their solvents to a mixer 26 and thus provide a gradient.

The conduit through which the solvent in reservoir B flows to the pumping system 24B has a high point 30 (sometimes referred to as an escape point) that is above other points in the line. At this point, there may be air in the line between the reservoir B and the pumping system 24B. The auxiliary solvent feeder 28 of the priming system 14 communicates with the high point 30 to pump air out of the system under the control of the conductor 51B from the controller 50 (FIG. 1) at the start up of the chromatographic run at which time the pumping system 24A is pumping one hundred percent of the solvent to the mixer 26 and the pumping system 24B is at zero and gradually will increase.

The auxiliary solvent feeder 28 pumps all of the air out of a line. This is known ahead of time from the length of the line and the volume and it is programmed into the controller 50 (FIG. 1). In the alternative, a sensor 33 which senses the absence of a liquid or senses the liquid depending on the configuration may be used to determine when all of the air is out of the line. In this manner, pump prime is maintained as the gradient is formed and supplied through a conduit 25 to the chromatographic elution, detection and/or collection system 15. A substantially complete system is shown at 15 in FIG. 2 but not all of the elements need be provided or in the sequence shown in FIG. 2 since the invention is applicable to different embodiments of liquid chromatography. However, in the system of FIG. 2, there is the sample injector 32, the column 16, the detector 18, and the fraction collection system 20.

In the embodiment of FIG. 2, the sample is maintained in a loop in the sample injector 32 but there are many other sample injectors well known in the art that may be used. The gradient moves the sample in the embodiment of FIG. 2 into the top of the column 16 and then elutes it within the column 16 so that the eluent may be detected by the detector 18 at the end of the column 16. Generally, the fraction collector system 20 includes a fraction collector 34 and a waste disposal 36. The fraction collector 34 in the embodiment of FIG. 2 receives the eluent and automatically fills containers in accordance with signals from the detector 18 with solvent not containing eluent being sent to the waste disposal 36.

The solvent supply system 12 communicates with the column 16 to supply solvent to the column 16 to provide a mobile phase to the column 16. In the preferred embodiment, the solvent supply system 12 communicates with the column 16 through the sample injector 32 to carry the sample into the top of the column 16, and after the sample has been injected into the column 16, to elute the eluate in the column 16, for detection and/or separation of analytes or target components in the eluate in the detector 18 and collection of the analytes or target components in the eluate by the fraction collection system 20. Thus, the analytes or target components of interest are first detected in the eluate, and then provided to the fraction collection system 20. The start up or priming systems communicate with the solvent supply system 12 to prime a first pumping system 24B when required.

The solvent supply system 12 is a gradient system solvent supply in the preferred embodiment, and in the embodiment of FIG. 2, includes the reservoir A 22A, the reservoir B 22B, the pumping systems 24A and 24B and the mixer 26. The controller 50 (FIG. 1) is connected to and controls the pumping systems 24A and 24B. The mixer 26 communicates with the pumping systems 24A and 24B to receive solvents and with the sample injector 32 to supply a mixture of solvents to the sample injector 32 for injection of sample into the column 16 and with the column 16 either directly or through the sample injector 32 to supply the mobile phase for chromatographic separation. The pumping systems 24A and 24B communicate with the reservoir A 22A to receive one solvent and with reservoir B 22B to receive another solvent if a two solvent gradient is to be used.

Under some circumstances, such as at initial start-up or a restarting after an interruption in supplying a gradient to change solvent reservoirs, there may be air in one of the solvent lines. In the case of the start up of a gradient profile, one or more of the reservoirs, commonly referred to as the B reservoir 22B in the embodiment of FIG. 2, initially provides zero amount of solvent into the final gradient. The A reservoir 22A in that case provides 100 percent of the solvent. At some later time, the solvent from B reservoir 22B starts being pumped and its volumetric rate of flow increases and the volumetric rate of flow of A solvent from the A reservoir 22A diminishes. Thus, the total volumetric rate of flow is constant and under the control of a program stored in the controller 50 (FIG. 1).

However, the solvent line for the B solvent in this example may contain air and thus initially the column 16 will receive some A and/or B solvent plus air. Later, when the air has been exhausted from the line or lines, a large amount of A solvent and/or B solvent will be dumped into the column 16 which may cause several compounds to be eluted at once thus preventing separation of the different peaks. This situation can occur at start up of a run but may also occur at any other instance in which air may enter one of the lines. Generally, the inlet lines to the pumps will be the largest diameter lines and the ones in which the fluid may drain during changing of a reservoir or introduction of a new reservoir. Any circumstance which causes air to fill one of the fluid lines between the reservoir and the column to have air may hereinafter from time to time be described in the specification as an “air gap”. If more than two solvents are to form the gradient, the air gap may occur at one time for the second solvent and at another time for the other solvent or solvents.

To prevent an air gap from interfering with the operation of the chromatograph, the start up or priming system or systems 14 pumps solvent into or pumps air out of a conduit or conduits that contains air until the air has been entirely removed. With this arrangement, the first pumping system 24B may pump continuously into the column 16. The outlet from the column 16 is, in a conventional manner, connected to the detector 18 to detect peaks and the fraction collection system 20 to collect particular separated components.

In the preferred embodiment, the time needed to pump air out of a line or to fill the line with solvent by pumping solvent into the line is known from the length of the line and its inside diameter (or volume). The volumetric pumping rate of the pump is also known. From this information, the time needed to prime the line is calculated and the pumping continued for a sufficient time to prime the line under the control of the controller 50 (FIG. 1). In another embodiment, air is pumped from the line until a solvent sensor 33 detects solvent at the high point of the line indicating that the line is free of air. In some embodiments, the solvent detector may be a liquid detector or an air detector (line is considered primed when no air is detected) but any means of detecting the solvent or absence of air may be used. Suitable sensors may be obtained from NetMotion Inc., 4160 Technology Drive, Fremont, Calif. 94538.

While one priming system 14 is shown in FIG. 2 to cooperate with one solvent line, there may be two or more such priming systems to cooperate with the same number of solvent lines that may begin pumping solvent after the gradient system has started or have air introduced any other time such as when changing solvents or replacing a solvent container.

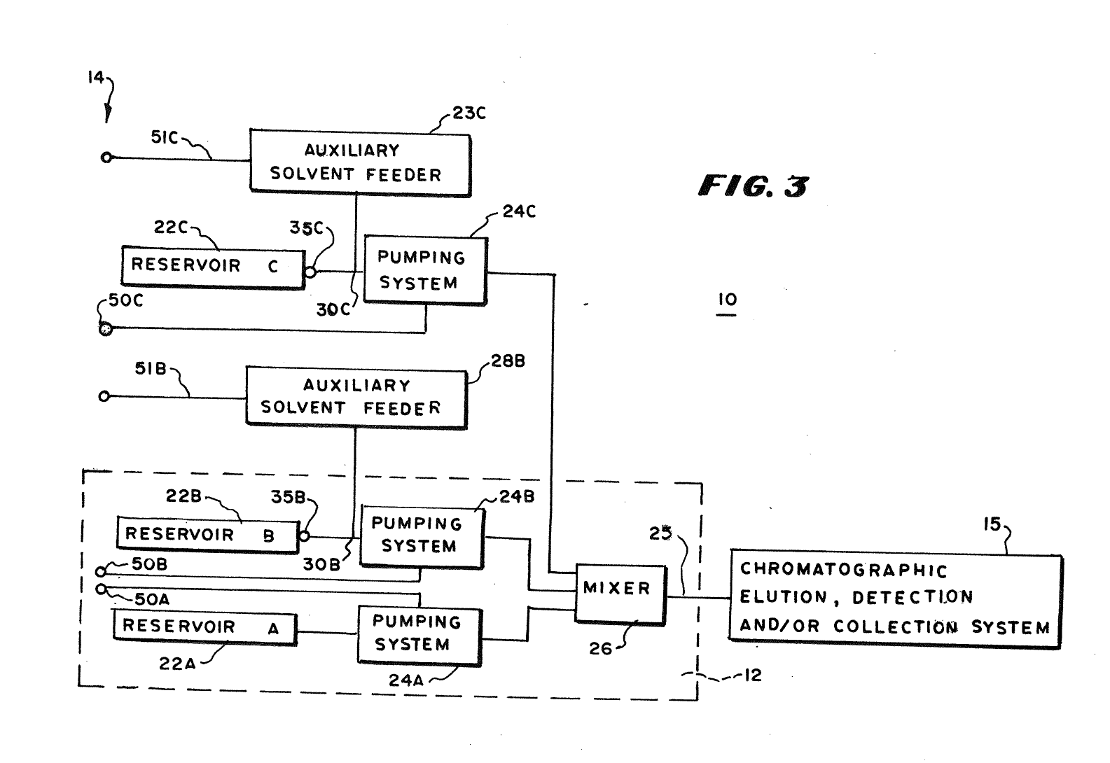

In FIG. 3, there is shown a block diagram of another embodiment 10B of priming system. In this system, three solvents contained in reservoir A indicated at 22A, reservoir B indicated at 22B and reservoir C indicated at 22C are utilized to form a gradient supplied to the chromatographic elution, detection and/or collection system 15 through a conduit 25. In this system, there are high points 30B in the line connecting reservoir B to pumping system 24B and high point 30C in the line connecting reservoir C to pumping system 24C. The pumping system 24A pumps solvent from the reservoir A to the mixer 26 where it is mixed with solvents from the pumping systems 24B and 24C. The lines connecting the reservoir B and the reservoir C may contain solvent up to the high points 30B and 30C respectively. To maintain prime, auxiliary solvent feeders 28B and 28C communicate with the high points and pump the air out under the control of conductors 51B and 51C from the controller 50 (FIG. 1). Instead of utilizing auxiliary solvent feeders in some embodiments, air is prevented from draining back from the lines by foot valves such as those shown at 35B and 35C to prevent solvent from draining from the high point back to the reservoir.

To pump a solvent mixture into the column 16 (FIG. 2), the solvent supply system 12 includes the first, second and third solvent reservoirs 22A, 22B and 22C or in some embodiments only two solvent reservoirs or more than three reservoirs, the first pumping system 24B and the mixer 26. In this embodiment, the first reservoir 22A includes a first solvent “A” and the second reservoir 22B includes a second solvent “B” and the third reservoir 22C includes a third solvent “C”. These reservoirs are connected to the first pumping system 24B which pumps solvent into the mixer 26 to form a gradient with a programmed percentage of solvent A, solvent B and in some embodiments still other solvents for supply to the column 16 (FIG. 2). While one embodiment including three solvent reservoirs is shown in the embodiment FIG. 3, there may be any number of reservoirs and instead of a separate mixer 26, the reservoirs may be mixed in a single pump or there may be an individual pump for each of the reservoirs. Indeed, there are many different configurations of solvent gradient systems that are well known in the art to which this invention may be applied.

To prevent air gaps from interfering with the chromatograph or delaying it, the start up or priming systems 14 each include an auxiliary solvent feeder 28 (the second pumping system) connected at a gravity high point 30 (solvent escape point). The auxiliary solvent feeder 28 pumps air or solvent from the solvent line at the gravity high point 30 under the control of the controller 50 to which it is connected. In the embodiment of FIG. 2, the gravity high point 30 is the highest location connected to an inlet conduit to the first pumping system 24. However, it may be connected to any point to which it will supply solvent to the conduit that has been filled with air or pump the air out so that the conduit will pull solvent in to replace the air.

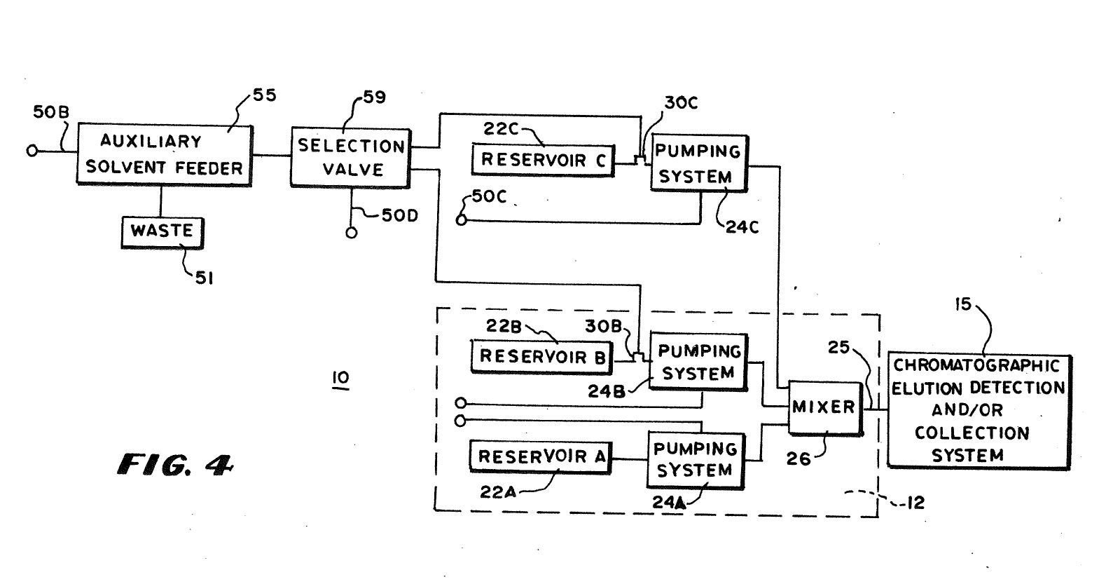

In FIG. 4, there is shown a block diagram of still another embodiment of the invention having a solvent supply system 12 similar to the solvent supply system 12 in FIGS. 2 and 3 communicating with a chromatographic elution, detection and/or collection system 15 through the conduit 25 in substantially the same manner as in the embodiment of FIG. 3. However, to supply additional solvents to the mixer 26 in the solvent supply system 12, a reservoir 22C communicates with a pumping system 24C to pump solvent to the mixer 26. However, in this embodiment, in order to remove air, a selection valve 59 controlled by the controller 50 (FIG. 1) through conductor 50D communicates with the high points 30B and 30C so that either of those high points may be evacuated by an auxiliary solvent feeder 55 that communicates with the selection valve 59. Thus, the selection valve 59 may be connected to either the high point 30B or the high point 30C to pump air out of the system under the control of the conductor 50B from the controller 50 (FIG. 1).

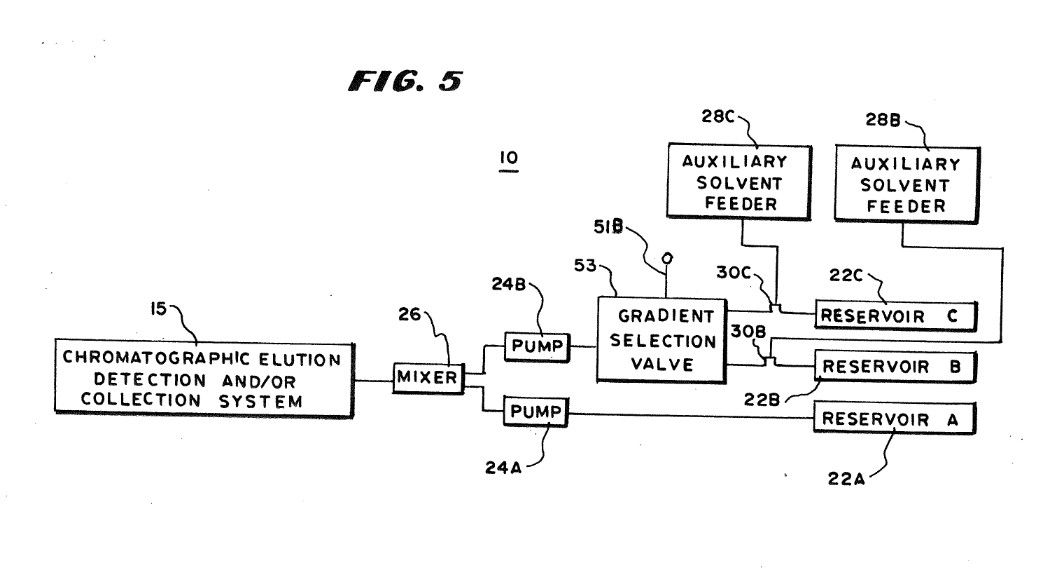

In FIG. 5, there is shown still another embodiment of priming system which includes a gradient selection valve 53 that communicates with auxiliary solvent feeder 28B at a high point 30C in the line from the reservoir C indicated at 22C and an auxiliary solvent feeder 28C that communicates with the high point 30B in the line between the gradient selection valve 53 and the reservoir B shown at 22B. The gradient selection valve 53 is under the control of the controller 50 (FIG. 1) through a conduit 51B. With this arrangement, the selection valve 53 selects either solvent from the reservoir C 22C or solvent from reservoir B 22B to be pumped to the mixer 26 by the pump 24B to be mixed with solvent from the reservoir 22A pumped by the pump 24A. If solvent from the reservoir B 22B is selected, then auxiliary solvent feeder 28B pumps air from the high point 30B and if solvent from reservoir C 22C is selected, then the auxiliary solvent feeder 28C pumps air from the high point 30C. In this manner, different gradients from different solvents may be selected by the solvent supply system.

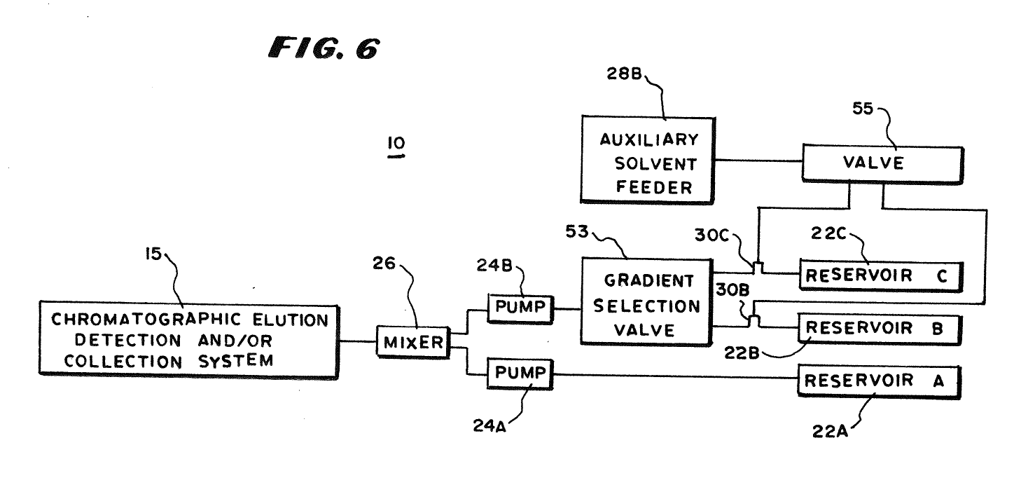

In FIG. 6, there is shown still another embodiment of priming system. This embodiment includes the gradient selection valve 53 but also includes a valve 55 which can select the appropriate reservoir high point 30B and 30C for air to be evacuated by the auxiliary solvent feeder 28B. In this manner, fewer auxiliary solvent feeders are needed since the valve can select the appropriate one.

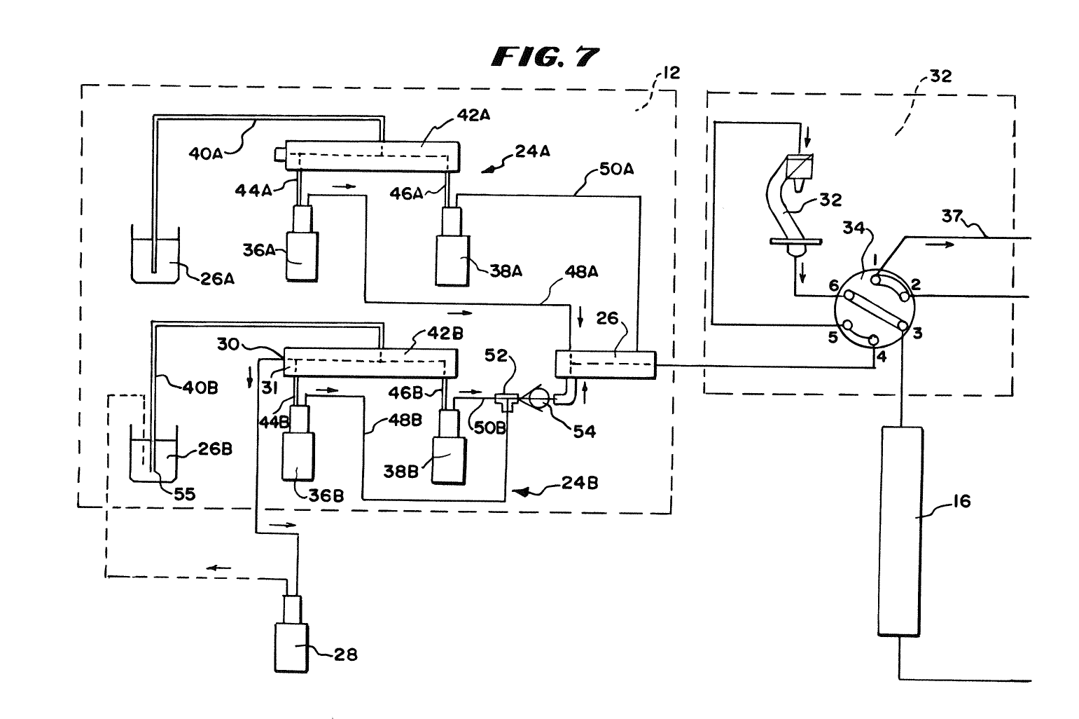

In FIG. 7, there is shown a schematic diagram of a system such as that shown in FIG. 2 for providing priming. As shown in that view, the two solvent gradient formers evacuate air from a line when required.

To supply solvent continuously in a mode where no air enters the inlet lines from a solvent reservoir 26A, a pumping system 24A includes an inlet conduit (tubing) 40A, a manifold 42A, inlet conduits (tubing) 44A and 46A and outlet capillary tubing (lines) 48A and 50A. With this arrangement, reciprocating pumps 36A and 38A alternately pull solvent from the manifold 42A. The solvent is pulled from the solvent reservoir 26A into the manifold 42A through the inlet conduit 40A. The inlet conduits 40A, 44A and 46A in one embodiment are three-eighths inch inside diameter tubing but because they are continually receiving solvent, no air gaps occur in them. The reciprocating pumps 36A and 38A pump solvent through the outlet capillary tubing 48A and 50A alternately into the mixer 26.

Similarly, a second pumping system includes coordinating reciprocating pumps 36B and 38B, a solvent B reservoir 26B, inlet conduit (tubing) 40B, a manifold 42B, inlet conduit (tubing) 44B and 46B, outlet capillary tubing (lines) 48B and 50B. This tubing is also connected to supply solvent B to the mixer 26. Solvent B is supplied to the mixer 26 through the T connection 52 and check valve 54 to prevent backflow of solvent A into the outlet capillary tubing 48B and 50B to reciprocating pumps 36B and 38B.

To avoid air from being introduced into the outlet capillary tubing 48B and 50B, the auxiliary solvent feeder 28 of the start up priming system 14 (FIG. 2) communicates with the manifold 42B through a fitting 31 and with the reservoir 26B. The auxiliary solvent feeder 28 in the embodiment of FIG. 2 draws air from the manifold 42B to prime the pump by removing air from the inlet tubing 40B. The inlet tubing because of its large diameter, which is three-eighths inch in the embodiment of FIG. 7 but may be any size as required by the pump design, is more likely to have air in it because it does not hold fluid by a capillary effect and so the fluid drains out of it from time to time under some circumstances and is replaced by air. The auxiliary solvent feeder 28 (FIG. 2) pulls out air but when the air is gone, may pull solvent and thus must be capable of both pulling a vacuum of adequate pressure to remove the air from an inlet line and pump solvent into the reservoir 26B. Moreover, the manifold 42B must be air tight to permit the drawing of the air from the inlet line 40B into the pump.

From the above description, it can be understood that the gradient elution start up systems of this invention has several advantages, such as: (1) they are automatic in their operation and do not waste operator time with priming; (2) they operate effectively even with large scale gradient chromatography such as may be used in preparatory chromatography including flash chromatography; and (3) they are relatively inexpensive in its operation.

Although a preferred embodiment of the invention has been described with some particularity, many modifications and variations of the invention are possible within the light of the above teachings. Therefore, it is to be understood that, within the scope of the pending claims, the invention may be practiced otherwise than as specifically described.

What is claimed is:

1. A method of operating a liquid chromatograph comprising the steps of:
supplying a first solvent through a first conduit in series with a chromatographic column;
supplying a second solvent through a second conduit in series with the chromatographic column, wherein at least one of the first and second conduits contains air; and
removing the air from the at least one of the first and second conduits.

2. The method in accordance with claim 1 wherein the step of removing the air from the at least one of the first and second conduits includes the step of pumping solvent into the at least one of the first and second conduits.

3. The method in accordance with claim 1 wherein the step of removing the air from the at least one of the first and second conduits includes the step of pumping air from the at least one of the first and second conduits until one of an absence of air or a presence of solvent is detected at an escape point in the at least one of the first and second conduits.

4. The method in accordance with claim 3 wherein the step of pumping air from the at least one of the first and second conduits includes the step of pumping air from an escape point.

5. A chromatographic system, comprising:
a first conduit;
a chromatographic column;
a pumping system for pumping a first solvent through said first conduit and into said chromatographic column;
a second conduit;
said pumping system being connected to the second conduit to pump solvent through the second conduit into said chromatographic column; and
a second pumping system in communication with one of said first and second conduits for removing air from said one of said first and second conduits.

6. A chromatographic system in accordance with claim 5 wherein said second pumping system is connected to pump solvent into said one of said first and second conduits.

7. A chromatographic system in accordance with claim 5 in which said second pumping system is connected to an escape point to pump air from said one of said first and second conduits.

8. A method of changing the composition of a gradient in a liquid chromatographic system, comprising the steps of:
decreasing at least a first volumetric rate of flow of at least a first solvent in at least a first conduit in the liquid chromatographic system;
increasing a volumetric rate of flow of at least one other solvent in at least one other conduit in the liquid chromatographic system as the rate of flow of the at least a first solvent is decreased in an amount that maintains the total volumetric flow rate of the combined at least a first solvent and the at least one other solvent constant;
removing any air in the at least first and the at least one other conduits; and
combining the at least first and the at least one other solvents to form the gradient.

9. A method in accordance with claim 8 wherein the step of removing any air in the at least first and the at least one other conduits includes the step of withdrawing air from the at least one other conduit.

10. A method in accordance with claim 8 wherein the step of removing any air in the at least first and the at least one other conduits includes the step of adding solvent to at least one other conduit.

11. A method in accordance with claim 8 wherein the step of increasing a volumetric rate of flow of at least one other solvent in an at least one other conduit in the liquid chromatographic system as the rate of flow of the at least a first solvent is decreased in an amount that maintains the total volumetric flow rate of the combined at least a first solvent and the at least one other solvent constant includes the step of increasing the volumetric rate of flow of at least a second solvent from a zero flow rate to a larger flow rate.

12. A method in accordance with claim 8 wherein the step of removing any air in the at least first and the at least one other conduits includes the step of sensing one of the absence of air or the presence of a solvent to control the timing of the removing of air.

13. A method in accordance with claim 8 wherein the step of removing any air in the at least first and the at least one other conduits includes the step of terminating removal of air at a time calculated from a length and an inside diameter of a conduit that contains air and the rate of pumping to control the timing of the withdrawing of the air.

14. A system for changing the composition of a gradient in a liquid chromatographic system, comprising:
a first pumping system;
first and second conduits;
said first and second conduits communicating with said first pumping system, wherein said first pumping system pumps solvent through the first and second conduits;
a controller;
a program residing in said controller;
said controller communicating with said first pumping system wherein said first pumping system pumps said solvent through said first and second conduits at volumetric flow rates, a sum of which is maintained equal at a programmed amount;
a mixing system for combining first and second solvents;
said controller being programmed to reduce the first solvent while increasing the second solvent under the control of the program;
a second pumping system communicating with at least one of the first and second conduits for removing air in the one of said first and second conduits, whereby the first and second conduits are primed at the start of volumetric flow in one of the first and second conduits.

15. The system of claim 14 wherein said second pumping system pumps air from said one of said first and second conduits until said one of said first and second conduits is fully primed.

16. The system in accordance with claim 14 in which said second pumping system pumps solvent into said one of said first and second conduits until said one of said first and second conduits is fully primed.

17. The system in accordance with claim 14 wherein said second pumping system is started by said controller at the same time that said first pumping system is started.

18. The system of claim 15 further including a sensor for sensing one of a presence of solvent or an absence of air; said sensor being mounted at an escape point and being in communications with the controller wherein pumping of air from the at least one conduit is terminated upon completion of priming.

19. A system for changing the composition of a gradient in a liquid chromatographic system, comprising:
a first pumping system;
first and second conduits;
said first and second conduits communicating with said first pumping system, wherein said first pumping system pumps solvent from corresponding first and second solvent reservoirs through the first and second conduits;
a controller;
a program residing in said controller;
said controller communicating with said first pumping system wherein said first pumping system pumps said solvent through said first and second conduits at volumetric flow rates, a sum of which is maintained equal at a programmed amount;
a mixing system for combining first and second solvents;
said controller being programmed to reduce the first solvent while increasing the second solvent under the control of the program;
said at least one of the first and second conduits including a foot valve whereby the at least one of the first and second conduits retains fluid so as to permit the first pumping system to remain primed when changing reservoirs.

20. A method of gradient elution, comprising the steps of:
decreasing at least a first volumetric rate of flow of at least a first solvent in at least a first conduit in a liquid chromatographic system;
increasing a volumetric rate of flow of at least one other solvent in at least one other conduit in the liquid chromatographic system as the rate of flow of the at least a first solvent is decreased in an amount that maintains the total volumetric flow rate of the combined at least a first solvent and the at least one other solvent constant;
replacing a solvent reservoir without losing prime by holding solvent in a conduit with a foot valve; and
combining the at least first and the at least one other solvents to form a gradient.

21. A method of performing gradient elution, comprising the steps of:
supplying a first solvent through a first conduit in series with a chromatographic column;
supplying a second solvent through a second conduit in series with the chromatographic column to perform gradient elution;
varying a volumetric rate of flow of the first and second solvents while maintaining a constant volumetric flow of solvent to the column; and
replacing at least one solvent reservoir while maintaining prime in said first and second conduits by one of removing air from at least one of the first and second conduits or maintaining solvent in said at least one of the first and second conduits with a foot valve.
